(19) United States
(12) Patent Application Publication
(10) Pub. No.: US 2025/0200796 A1
(43) Pub. Date: Jun. 19, 2025

(54) MARKER APPARATUS, COMPUTER SYSTEM, METHOD, AND PROGRAM

(71) Applicant: Sony Interactive Entertainment Inc., Tokyo (JP)

(72) Inventors: Akihiro TAKANO, Tokyo (JP); Tetsugo INADA, Tokyo (JP)

(73) Assignee: Sony Interactive Entertainment Inc., Tokyo (JP)

(21) Appl. No.: 18/847,266

(22) PCT Filed: Mar. 23, 2022
(86) PCT No.: PCT/JP2022/013412

§ 371 Date: Sep. 16, 2024

(51) Int. Cl. G06T 7/73; G06T 7/529; G06V 10/54; G06V 10/60; G06V 10/62; G06V 10/77

(52) U.S. Cl. CPC G06T 7/74; G06T 7/529; G06V 10/54; G06V 10/60; G06V 10/62; G06V 10/7715; G06T 2207/30204

(57) ABSTRACT

There is provided a marker apparatus disposed in a real space for detecting a position in the real space in an image. The marker apparatus includes a light emitting part configured to display a pattern that appears as a shape having a size in the image. Furthermore, there is provided a computer system for detecting a position in a real space in an image. The computer system includes a memory for storing a program code and a processor for executing operation in accordance with the program code. The operation includes transmitting a control signal for displaying a pattern that appears as a shape having a size in the image, to a marker apparatus disposed in the real space.

### TECHNICAL FIELD

The present invention relates to a marker apparatus, a computer system, a method, and a program.

### BACKGROUND ART

In the field called virtual reality or augmented reality, detecting a position in a real space in an image by using a marker disposed in the real space is known. For example, PTL 1 describes a technique in which information regarding the position and posture of a device including a light emitting marker is acquired by using an image obtained by shooting the device with an exposure time shorter than the time of one frame. The light emitting marker emits light with a light emission time equal to or shorter than the exposure time. An information processing apparatus can cause the light emitting marker to emit light with a predetermined lighting-on/lighting-off pattern, and identify the exposure time on the time axis of the device according to whether or not a figure of the light emitting marker in a shot image thereof exists, and synchronize the exposure and the light emission.

Meanwhile, the event-based vision sensor, in which a pixel that has detected intensity change of incident light generates a signal asynchronously in terms of time, is known. The event-based vision sensor is advantageous in that it has a high time resolution and can operate by low power compared with the frame-based vision sensor, which scans all pixels at a predetermined cycle, specifically, image sensors of CCD (Charge-Coupled Device), CMOS (Complementary Metal Oxide Semiconductor), and the like. Techniques relating to such an event-based vision sensor are described in PTL 2 and PTL 3, for example.

### Citation List

### Patent Literature

PTL 1

JP 2020-088822A
PTL 2

JP 2014-535098A
PTL 3

JP 2018-85725A

### SUMMARY

### Technical Problem

For example, in the case of imaging a marker disposed in a real space by the above-described event-based vision sensor, a situation different from that in the case of using the frame-based vision sensor possibly occurs because of the nature that an event signal is generated in response to intensity change of light. However, a technique to deal with such a situation has not yet been proposed.

Thus, the present invention intends to provide a marker apparatus, a computer system, a method, and a program that can optimize detection of a marker in an image in response to a wide variety of situations in detecting a position in a real space in an image by using the marker disposed in the real space.

### Solution to Problem

According to a certain aspect of the present invention, there is provided a marker apparatus disposed in a real space for detecting a position in the real space in an image. The marker apparatus includes a light emitting part configured to display a pattern that appears as a shape having a size in the image.

According to another aspect of the present invention, there is provided a computer system for detecting a position in a real space in an image. The computer system includes a memory for storing a program code and a processor for executing operation in accordance with the program code. The operation includes transmitting a control signal for displaying a pattern that appears as a shape having a size in the image, to a marker apparatus disposed in the real space.

According to further another aspect of the present invention, there is provided a method for detecting a position in a real space in an image. The method includes, by operation executed by a processor in accordance with a program code stored in a memory, transmitting a control signal for displaying a pattern that appears as a shape having a size in the image, to a marker apparatus disposed in the real space.

According to yet another aspect of the present invention, there is provided a program for detecting a position in a real space in an image. Operation executed by a processor in accordance with the program includes transmitting a control signal for displaying a pattern that appears as a shape having a size in the image, to a marker apparatus disposed in the real space.

### BRIEF DESCRIPTION OF DRAWINGS

FIG. 1 is a diagram illustrating an example of a system according to one embodiment of the present invention.

FIG. 2 is a diagram illustrating the apparatus configuration of the system illustrated in FIG. 1.

FIG. 3 is a flowchart illustrating the overall flow of processing executed in the system illustrated in FIG. 1.

FIG. 4 is a diagram illustrating a first example of a pattern to be displayed by a marker apparatus in one embodiment of the present invention.

FIG. 5 is a diagram illustrating a second example of the pattern to be displayed by the marker apparatus in one embodiment of the present invention.

FIG. 6 is a flowchart illustrating an example of processing of deciding the pattern to be displayed by the marker apparatus in one embodiment of the present invention.

FIG. 7 is a diagram illustrating an example of a pattern that is displayed by the marker apparatus and temporally changes in one embodiment of the present invention.

### DESCRIPTION OF EMBODIMENTS

Several embodiments of the present invention will be described in detail below with reference to the accompanying drawings. Note that, in the present specification and the drawings, overlapping description is omitted by giving the same reference sign regarding a constituent element having substantially the same functional configuration.

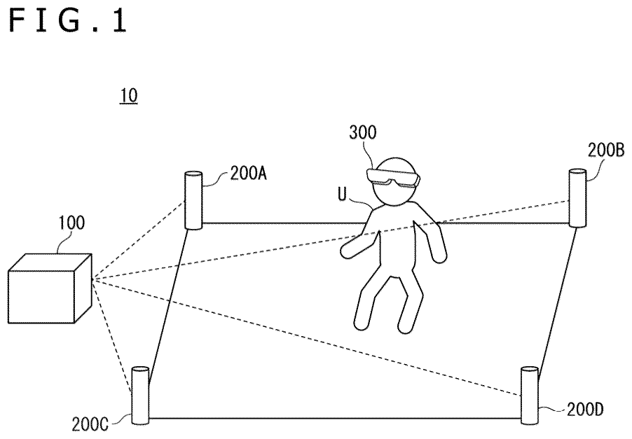

FIG. 1 is a diagram illustrating an example of a system according to one embodiment of the present invention. In the illustrated example, a system 10 includes a computer 100, marker apparatuses 200A to 200D, and a head-mounted display (HMD) 300. For example, the computer 100 is a game machine, a personal computer (PC), or a server apparatus connected to a network. The marker apparatuses 200A to 200D are disposed at, for example, the outer edge of a predetermined region or the boundary of a part excluded from the predetermined region in a real space in which a user U exists. The HMD 300 is worn by the user U and displays an image in the field of view of the user U by a display apparatus. In addition, the HMD 300 acquires an image corresponding to the field of view of the user U by using a vision sensor to be described later. By detecting a marker apparatus 200 included in an image acquired by the HMD 300 as a subject, the position at which the marker apparatus 200 is disposed in the real space can be detected in the image, and, for example, the position can be reflected in the image displayed in the field of view of the user U.

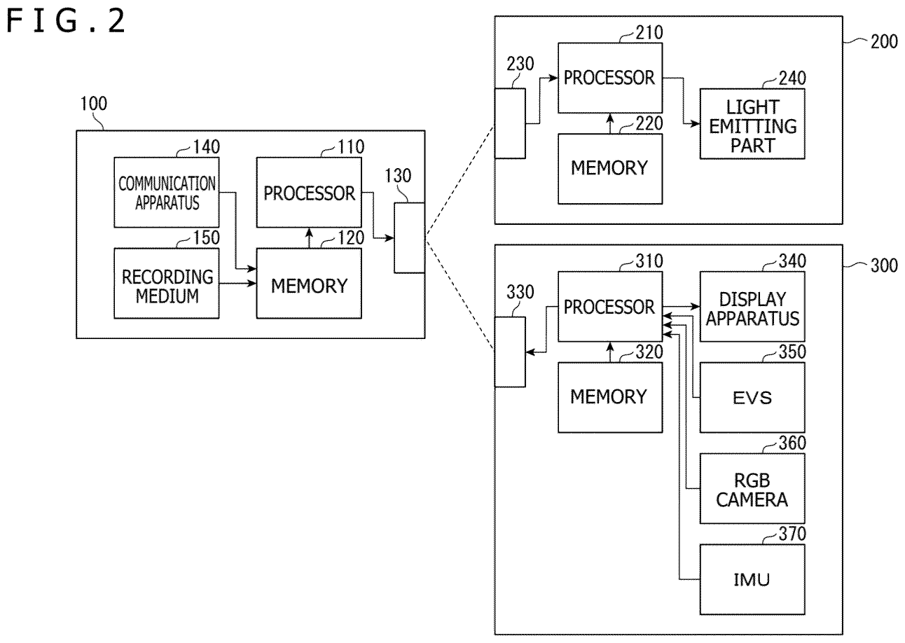

FIG. 2 is a diagram illustrating the apparatus configuration of the system illustrated in FIG. 1. Note that the marker apparatus 200 illustrated in FIG. 2 corresponds to each of the marker apparatuses 200A to 200D illustrated in FIG. 1. The computer 100, the marker apparatus 200, and the HMD 300 each include a processor and a memory. Specifically, the computer 100 includes a processor 110 and a memory 120. The marker apparatus 200 includes a processor 210 and a memory 220. The HMD 300 includes a processor 310 and a memory 320. These processors include processing circuits such as a CPU (Central Processing Unit), a DSP (Digital Signal Processor), an ASIC (Application Specific Integrated Circuit), and/or an FPGA (Field-Programmable Gate Array), for example. Further, the memories include storage apparatuses such as various kinds of ROM (Read Only Memory), RAM (Random Access Memory), and/or HDD (Hard Disk Drive), for example. Each processor operates in accordance with a program code stored in the memory.

Moreover, the computer 100, the marker apparatus 200, and the HMD 300 each include a communication interface. Specifically, the computer 100 includes a communication interface 130. The marker apparatus 200 includes a communication interface 230. The HMD 300 includes a communication interface 330. These communication interfaces execute wireless communication of, for example, Bluetooth (registered trademark), Wi-Fi, WUSB (Wireless Universal Serial Bus), or the like. Transmission and reception of data by wireless communication are possible between the computer 100 and the marker apparatus 200 and between the computer 100 and the HMD 300. In another embodiment, transmission and reception of data may be possible also between the marker apparatus 200 and the HMD 300. Furthermore, in another embodiment, wired communication may be used instead of the wireless communication or in addition to the wireless communication. In the case of the wired communication, for example, a LAN (Local Area Network), the USB, or the like is used.

In the illustrated example, the computer 100 further includes a communication apparatus 140 and a recording medium 150. For example, a program code for causing the processor 110 to operate as described below may be received from an external apparatus through the communication apparatus 140 and be stored in the memory 120. Alternatively, the program code may be read into the memory 120 from the recording medium 150. The communication apparatus 140 may be an apparatus common with the communication interfaces included in the respective apparatuses like the above-described ones, or may be a different apparatus. For example, the communication interface of each apparatus may execute communication by a closed communication network, whereas the communication apparatus 140 may execute communication by an open communication network such as the Internet. The recording medium 150 includes, for example, a removable recording medium such as a semiconductor memory, a magnetic disc, an optical disc, or a magneto-optical disc and a driver for it.

Moreover, in the illustrated example, the marker apparatus 200 further includes a light emitting part 240. For example, the light emitting part 240 may be a simple light emitting apparatus like an LED (Light Emitting Diode) array, or the light emitting part 240 may include a display apparatus like an LCD (Liquid Crystal Display) or an organic EL (Electro-Luminescence) display. In either case, the light emitting part 240 is configured to be capable of displaying, for example, a linear or planar pattern according to control by the processor 210. In either case, luminance change caused by lighting-on or lighting-off of the light emitting part 240 according to a pattern appears as a shape having a size in an image. In the present embodiment, the processor 210 of the marker apparatus 200 controls the light emitting part 240 according to a control signal received from the computer 100 through the communication interface 230.

Furthermore, in the illustrated example, the HMD 300 further includes a display apparatus 340, an event-based vision sensor (EVS) 350, an RGB (Red, Green, and Blue) camera 360, and an inertial measurement unit (IMU) 370. The display apparatus 340 includes, for example, an LCD (Liquid Crystal Display) or an organic EL (Electro-Luminescence) display, and displays an image in the field of view of the user U. The EVS 350 is referred to also as an EDS (Event Driven Sensor), an event camera, or a DVS (Dynamic Vision Sensor), and includes a sensor array including sensors including a light receiving element. In the EVS 350, when the sensor has detected intensity change, more specifically, luminance change, of incident light, an event signal including a timestamp, identification information of the sensor, and information regarding the polarity of the luminance change is generated. On the other hand, the RGB camera 360 is a frame-based vision sensor like, for example, a CMOS image sensor or a CCD image sensor, and acquires an image of the real space in which the marker apparatus 200 is disposed. The IMU 370 includes, for example, a gyro sensor and an acceleration sensor, and detects angular velocity and acceleration generated in the HMD 300.

In the present embodiment, the processor 310 of the HMD 300 causes the display apparatus 340 to display an image according to a control signal and an image signal received from the computer 100 through the communication interface 330. Moreover, the processor 310 transmits the event signal generated by the EVS 350, an image signal acquired by the RGB camera 360, and an output value of the IMU 370 to the computer 100 through the communication interface 330. Here, the positional relation between the EVS 350, the RGB camera 360, and the IMU 370 is known. That is, each sensor forming the sensor array of the EVS 350 is associated with the pixel of the image acquired by the RGB camera 360. Furthermore, the angular velocity and the acceleration detected by the IMU 370 are associated with change in the angle of view of the image acquired by the RGB camera 360. The processor 310 may transmit, to the computer 100, information that allows these kinds of associating, for example, a timestamp and identification information of data, together with the event signal, the image signal, and the output value.

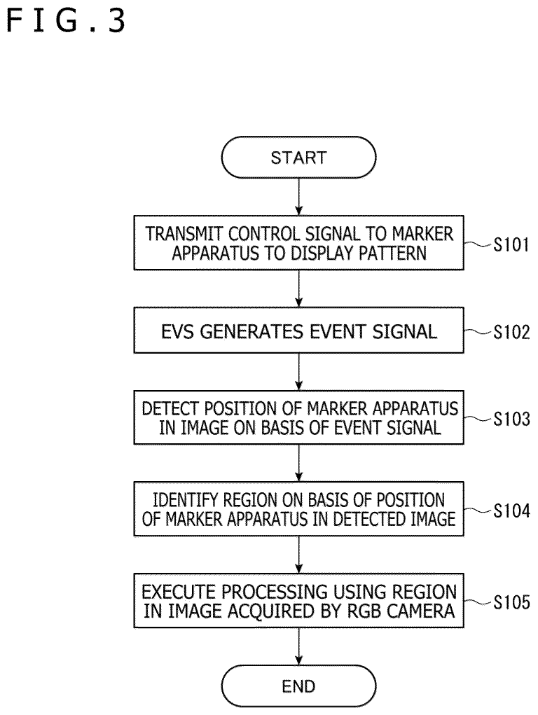

FIG. 3 is a flowchart illustrating the overall flow of processing executed in the system illustrated in FIG. 1. In the illustrated example, first, the processor 110 of the computer 100 transmits a control signal to the marker apparatus 200 to cause the marker apparatus 200 to display a predetermined pattern (step S101). At this time, the processor 110 may decide the pattern to be displayed according to the recognition result of the image acquired by the RGB camera 360 or the output value of the IMU 370 as described later. Moreover, as described above, the pattern to be displayed in the marker apparatus 200 in the present embodiment appears as a shape having a size, that is, a shape that ranges over two or more pixels, in the image acquired by the RGB camera 360. When the pattern is displayed in the marker apparatus 200, luminance change occurs due to lighting-on or lighting-off of the light emitting part 240 in the marker apparatus 200 or change in the positional relation between the EVS 350 and the marker apparatus 200 through the occurrence of displacement or rotation of the HMD 300 in the state in which the pattern is displayed in the marker apparatus 200. Thus, the EVS 350 generates the event signal (step S102).

The processor 110 of the computer 100 detects the position of the marker apparatus 200 in the image on the basis of the event signal transmitted from the HMD 300 (step S103). For example, the processor 110 may detect, as the position of the marker apparatus 200, the position of the pixel associated with the sensor of the EVS 350 that has detected luminance change with a spatial pattern corresponding to the pattern of lighting-on or lighting-off of the light emitting part 240. At this time, by deciding the pattern to be displayed by the marker apparatus 200 on the basis of a condition to be described later, the processor 110 can detect the position of the marker apparatus 200 swiftly and accurately. In this case, for example, the processor 110 detects the position of the marker apparatus 200 in the above-described manner after narrowing down a region in which an event has occurred in the case in which an event has not occurred in the other regions in the image or a region in which an event has not occurred in the case in which an event has occurred in the other regions in the image as the region in which the marker apparatus 200 exists.

Furthermore, the processor 110 of the computer 100 identifies a region on the basis of the position of the marker apparatus 200 in the detected image (step S104). For example, the processor 110 may identify a region surrounded by the marker apparatuses 200A to 200D like that illustrated in FIG. 1 as a predetermined region in a real space or a part excluded from the predetermined region. Alternatively, the processor 110 may identify a region near one or multiple marker apparatuses 200 as a region in which a specific object exists in a virtual space. In addition, the processor 110 may execute processing using the identified region in the image acquired by the RGB camera 360 (step S105). For example, the processor 110 may execute marking of the region identified in the image as a region into which entry is possible/impossible, or display a virtual object in the identified region. The image for which the processing has been executed in step S105 is transmitted to the HMD 300 as image data, and is displayed in the field of view of the user U by the display apparatus 340.

Note that how to use the position of the marker apparatus 200 detected in the image is decided according to an application provided by the system 10 and is not particularly limited to any method. Therefore, the processor 110 of the computer 100 does not necessarily need to reflect the detected position of the marker apparatus 200 in the image acquired by the RGB camera 360. For example, the processor 110 may change the magnitude of vibrations or auditory output provided to the user by another apparatus included in the system 10 depending on whether or not the marker apparatus 200 exists in the image. Alternatively, the processor 110 may give the user a score in a game depending on the position of the marker apparatus 200 in the image.

According to the configuration of the above-described present embodiment, the position of the marker apparatus 200 is detected by using the event signal generated by the EVS 350, which is the event-based vision sensor having a higher time resolution than the frame-based vision sensor. Therefore, the detection can be executed swiftly and accurately with reduction in the influence of a motion blur attributed to motion of the sensors themselves mounted in the HMD 300. Here, for example, in the case in which a marker displays a pattern that does not have a size in an image, that is, a pattern recognized as a substantial dot, a time series of light emission, that is, repetition of multiple times of lighting-on and lighting-off, needs to be captured for identification of the marker. In contrast, in the present embodiment, the pattern to be displayed by the marker apparatus 200 appears as a shape having a size in an image. Therefore, for example, after the marker apparatus 200 is identified by the event signal generated through one time of lighting-on or lighting-off, the position thereof can be detected. In such a manner, rapid and accurate position detection of the marker by sufficient utilization of the high time resolution of the event-based vision sensor is enabled in the present embodiment.

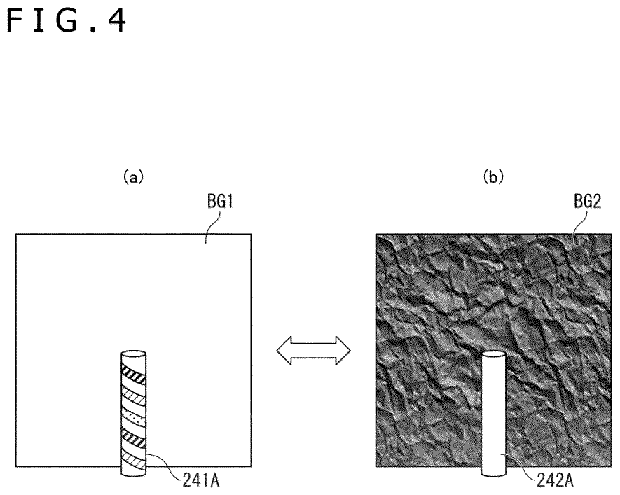

FIG. 4 is a diagram illustrating a first example of a pattern to be displayed by the marker apparatus in one embodiment of the present invention. In the illustrated example, the pattern is decided according to the texture of the background of the marker apparatus 200. Specifically, the light emitting part 240 of the marker apparatus 200 displays a first pattern 241A including spatial luminance change and a second pattern 242A that does not include spatial luminance change with switching therebetween. More specifically, the first pattern 241A including spatial luminance change is displayed in the case in which the texture of a background BG1 is sparse as illustrated as (a) in FIG. 4, specifically, in the case in which the background is plain with a single color or is a space with nothing. On the other hand, the second pattern 242A that does not include spatial luminance change is displayed in the case in which the texture of a background BG2 is dense as illustrated as (b) in FIG. 4, specifically, in the case in which a relatively large number of edges attributed to color difference or the boundary of an object exist in the background.

Here, the spatial luminance change in the pattern means that a part with relatively high luminance and a part with relatively low luminance are substantially simultaneously displayed in, for example, a linear or planar pattern. For example, a pattern in which the luminance changes at a plurality of stages may be displayed as in the illustrated example. Note that, although the light emitting part 240 is formed into a cylindrical surface shape and the first pattern 241A including luminance change with an oblique stripe shape is exemplified in the diagram, the pattern including spatial luminance change is not limited to the stripe shape and a pattern with, for example, a dot shape, a mosaic shape, or the like is also possible. Moreover, the shape of the light emitting part 240 is not limited to the cylindrical surface shape and may be a flat surface shape, for example. On the other hand, although the second pattern 242A made by lighting off (or lighting on) the whole of the light emitting part 240 is exemplified in the diagram, the spatial luminance change in the second pattern 242A is not entirely inadmissible. In the second pattern 242A in another example, spatial luminance change less than that in the first pattern 241A may be included.

In the case in which the texture of the background BG1 of the marker apparatus 200 is sparse as in (a) of FIG. 4, even when the positional relation between the EVS 350 and objects in the space including the marker apparatus 200 changes due to the occurrence of displacement or rotation in the HMD 300, an event does not occur in principle because the luminance does not change in the background part. In such a case, when the first pattern 241A including spatial luminance change is displayed in the marker apparatus 200, many events occur in the part of the light emitting part 240 of the marker apparatus 200 in contrast to the background part. Therefore, the position of the marker apparatus 200 can be detected swiftly and accurately by narrowing down the region in which the marker apparatus 200 exists.

On the other hand, in the case in which the texture of the background BG2 of the marker apparatus 200 is dense as in (b) of FIG. 4, when the positional relation between the EVS 350 and objects in the space including the marker apparatus 200 changes due to the occurrence of displacement or rotation in the HMD 300, many events occur due to change in the luminance in the whole of the background part. In such a case, when the second pattern 242A that does not include spatial luminance change or includes less spatial luminance change is displayed in the marker apparatus 200, less events occur in the part of the light emitting part 240 of the marker apparatus 200 in contrast to the background part. Therefore, the position of the marker apparatus 200 can be detected swiftly and accurately by narrowing down the region in which the marker apparatus 200 exists, as in (a).

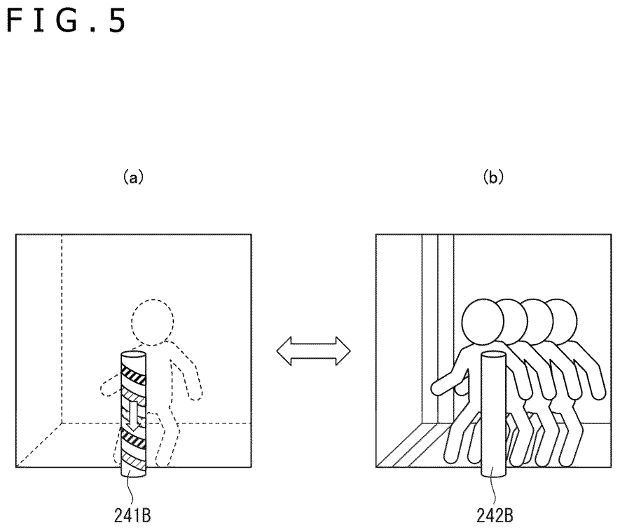

FIG. 5 is a diagram illustrating a second example of the pattern to be displayed by the marker apparatus in one embodiment of the present invention. In the illustrated example, the pattern to be displayed is decided according to the speed of motion that occurs in an image including the marker apparatus 200 as a subject. Specifically, the light emitting part 240 of the marker apparatus 200 displays a first pattern 241B that includes spatial luminance change and temporally changes and a second pattern 242B that does not include spatial luminance change and hence does not temporally change, with switching therebetween. More specifically, the first pattern 241B is displayed in the case in which the speed of motion that occurs in the image acquired by the RGB camera 360 is low as illustrated as (a) in FIG. 5. On the other hand, the second pattern 242B is displayed in the case in which the speed of motion that occurs in the image acquired by the RGB camera 360 is high as illustrated as (b) in FIG. 5.

Note that, although the light emitting part 240 is formed into a cylindrical surface shape and the first pattern 241B in which luminance change with an oblique stripe shape moves in the axial direction of the cylindrical surface at a predetermined speed is exemplified in the diagram, a pattern with, for example, a dot shape, a mosaic shape, or the like is also possible as in the example of FIG. 4 and the temporal change is not limited to the movement in one direction. Moreover, the shape of the light emitting part 240 is not limited to the cylindrical surface shape and may be a flat surface shape, for example. On the other hand, the second pattern 242B made by lighting off (or lighting on) the whole of the light emitting part 240 is exemplified in the diagram. However, spatial luminance change less than that in the first pattern 241B may be included in the second pattern 242B as in the example of FIG. 4, and temporal luminance change smaller than that in the first pattern 241B may exist in the second pattern 242B.

In the case in which the motion of the user U who wears the HMD 300 is small, the speed of motion that occurs in the image acquired by the RGB camera 360 becomes low as in FIG. 5 (a). In such a case, change in the positional relation between the EVS 350 and objects in the space including the marker apparatus 200 is small. Therefore, if there is no temporal change in the pattern to be displayed in the marker apparatus 200, an event does not occur in the whole of the image including the marker apparatus 200, and it becomes difficult to detect the marker apparatus 200 on the basis of the event signal. In such a case, when the first pattern 241B that includes spatial luminance change and temporally changes is displayed in the marker apparatus 200, many events occur in the part of the light emitting part 240 of the marker apparatus 200 in contrast to the other parts. Therefore, the position of the marker apparatus 200 can be detected swiftly and accurately by narrowing down the region in which the marker apparatus 200 exists.

On the other hand, in the case in which the motion of the user U who wears the HMD 300 is large, the speed of motion that occurs in the image acquired by the RGB camera 360 becomes high as in FIG. 5 (b). In this case, change in the positional relation between the EVS 350 and objects in the space including the marker apparatus 200 is large. Therefore, if the pattern to be displayed in the marker apparatus 200 includes spatial luminance change, many events occur in the whole of the image including the marker apparatus 200. Thus, it becomes difficult to detect the marker apparatus 200 on the basis of the event signal. In such a case, when the second pattern 242B that does not include spatial luminance change and hence does not temporally change is displayed in the marker apparatus 200, less events occur in the part of the light emitting part 240 of the marker apparatus 200 in contrast to the other parts. Therefore, the position of the marker apparatus 200 can be detected swiftly and accurately by narrowing down the region in which the marker apparatus 200 exists, as in (a).

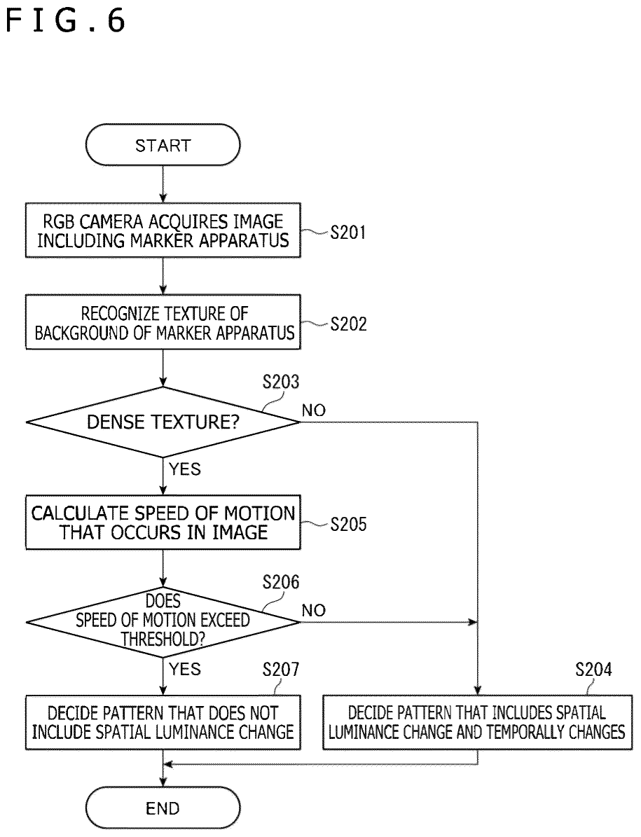

FIG. 6 is a flowchart illustrating an example of processing of deciding the pattern to be displayed by the marker apparatus in one embodiment of the present invention. In the illustrated example, first, the RGB camera 360 mounted in the HMD 300 acquires an image including the marker apparatus 200 as a subject (step S201). The image is transmitted from the HMD 300 to the computer 100, and the processor 110 of the computer 100 recognizes the texture of the background of the marker apparatus 200 by analysis of the image (step S202). The texture of the background is recognized on the basis of color density change in the image, for example. More specifically, the processor 110 may determine that the texture of the background is dense in the case in which the amplitude and/or the frequency of color density change in a predetermined region of the background exceeds a threshold, and determine that the texture of the background is sparse if not so. In the case in which the recognized background has a dense texture (YES of S203), the processor 110 executes further determination. On the other hand, in the case in which the background is not dense, that is, has a sparse texture (NO of S203), the processor 110 decides a pattern that includes spatial luminance change and temporally changes (step S204).

In the case in which it has been determined that the background has a dense texture in the above-described step S203, the processor 110 of the computer 100 calculates the speed of motion that occurs in the image acquired by the RGB camera 360 (step S205). The magnitude of the speed of motion that occurs in the image is calculated on the basis of, for example, the frequency of generation of the event signal by the EVS 350, the magnitude of the motion vector of the image acquired by the RGB camera 360, or angular velocity and acceleration detected by the IMU 370. In the case in which the speed of motion that occurs in the image exceeds a threshold (YES of step S206), the processor 110 decides a pattern that does not include spatial luminance change and hence does not temporally change (step S207). On the other hand, in the case in which the speed of motion does not exceed the threshold (NO of step S206), the processor 110 decides a pattern that includes spatial luminance change and temporally changes (step S204).

In the example illustrated in FIG. 6 in the above, either a first pattern that includes spatial luminance change and temporally changes (step S204) or a second pattern that does not include spatial luminance change and hence does not temporally change (step S207) is displayed. In the case in which the texture of the background is sparse, less events occur in the whole of the image irrespective of the speed of motion that occurs in the image. Therefore, it is desirable to display the first pattern to cause an event at the part of the marker apparatus 200. Furthermore, in the case in which the speed of motion that occurs in the image is low although the texture of the background is dense, less events occur in the whole of the image. Therefore, it is desirable to display the first pattern also in this case. On the other hand, in the case in which the texture of the background is dense and the speed of motion that occurs in the image is high, many events occur in the whole of the image. Therefore, it is desirable to display the second pattern to suppress the occurrence of an event at the part of the marker apparatus 200.

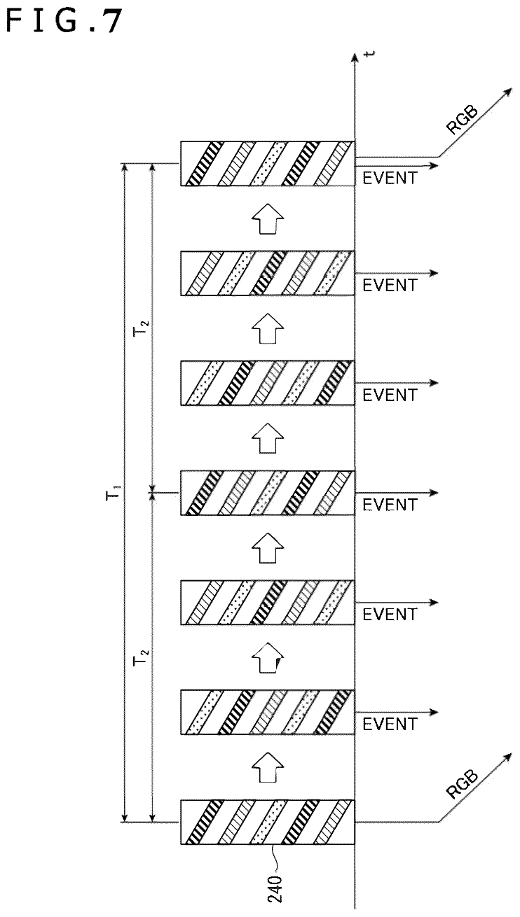

FIG. 7 is a diagram illustrating an example of a pattern that is displayed by the marker apparatus and temporally changes in one embodiment of the present invention. In the illustrated example, the light emitting part 240 of the marker apparatus 200 displays a pattern that includes spatial luminance change and temporally changes at a rate that is an integer multiple of, specifically, is twice, the frame rate of the RGB camera 360, which is a frame-based vision sensor. More specifically, in the case in which the RGB camera 360 executes scanning of a frame at a cycle T₁, the pattern to be displayed in the marker apparatus 200 temporally changes at a cycle T₂=T₁/2. As a result, in the image of the RGB camera 360, the marker apparatus 200 appears to display the same pattern in every frame, that is, the pattern of the marker apparatus 200 appears not to temporally change. In this case, the temporal change in the pattern of the marker apparatus 200 is less likely to become noisy visual information for the user U in the image acquired by the RGB camera 360. On the other hand, in the EVS 350, the event signal is generated every time the pattern temporally changes at the cycle T₂. Therefore, the marker apparatus 200 can be easily detected on the basis of the event signal.

Note that various changes are possible irrespective of exemplified contents in the embodiments of the present invention described above. For example, the pattern to be displayed by the marker apparatus 200 is decided by the computer 100 in the above-described examples. However, a similar function may be implemented by the processor of the marker apparatus 200 or the HMD 300, and either of these apparatuses may decide the pattern to be displayed by the marker apparatus 200.

Moreover, the position of the marker apparatus 200 is detected on the basis of the event signal of the EVS 350, which is an event-based vision sensor, in the above-described examples. However, it is also possible to detect the position of the marker apparatus 200 by analysis of an image acquired by a frame-based vision sensor like the RGB camera 360. Also in this case, the pattern to be displayed by the marker apparatus 200 appears as a shape having a size in the image, that is, a shape that ranges over two or more pixels. This can detect and identify the marker apparatus 200 with, for example, an image of one frame irrespective of the time series of light emission. In this case, the pattern to be displayed by the marker apparatus 200 may be decided according to the background as in the example in which the pattern to be displayed by the marker apparatus 200 is decided according to the texture of the background in the above-described examples. In this case, for example, a pattern with a color that will serve as a complementary color of the color of the background may be decided.

Furthermore, as further another example, the marker apparatus may be mounted in a movable object. Specifically, for example, the marker apparatus is mounted in a ball used in a game, and a pattern is displayed on the surface of the ball. This can swiftly and accurately detect, in an image, the position of the ball that irregularly moves in a real space due to play of the game. Moreover, for example, by mounting the marker apparatus in a drone or the like that flies in a real space and displaying a pattern on the surface of the drone, a companion character or the like may be displayed in a virtual space in synchronization with motion of an object that moves in the real space.

The embodiments of the present invention have been described in detail above with reference to the accompanying drawings. However, the present invention is not limited to these examples. It is obvious that those having general knowledge in technical fields to which the present invention belongs can conceive of various modification examples and amendment examples within the category of technical ideas set forth in the scope of claims, and it is understood that naturally they also belong to the technical scope of the present invention.

### Reference Signs List

10: System
100: Computer
110: Processor
120: Memory
130: Communication interface
140: Communication apparatus
150: Recording medium
200: Marker apparatus
210: Processor
220: Memory
230: Communication interface
240: Light emitting part
241A, 241B: First pattern
242A, 242B: Second pattern
300: HMD
310: Processor
320: Memory
330: Communication interface
340: Display apparatus
350: DVS
360: RGB camera
370: IMU

1. A marker apparatus disposed in a real space for detecting a position in the real space in an image, the marker apparatus comprising:
a light emitting part configured to display a pattern that appears as a shape having a size in the image, wherein
the pattern includes a first pattern that includes spatial luminance change and temporally changes and a second pattern in which spatial luminance change is less than the spatial luminance change in the first pattern or spatial luminance change does not exist, and
the light emitting part is capable of displaying the first pattern and the second pattern with switching between the first pattern and the second pattern.

2. The marker apparatus according to claim 1, wherein
the pattern includes a linear or planar pattern.

3.-5. (canceled)

6. A computer system for detecting a position in a real space in an image, the computer system comprising:
a memory for storing a program code; and
a processor for executing operation in accordance with the program code,
the operation including transmitting a control signal for displaying a pattern that appears as a shape having a size in the image, to a marker apparatus disposed in the real space, wherein
the pattern includes a first pattern including spatial luminance change and a second pattern in which spatial luminance change is less than the spatial luminance change in the first pattern or spatial luminance change does not exist, and
the operation further includes transmitting, to the marker apparatus, a control signal for displaying the first pattern and the second pattern with switching between the first pattern and the second pattern.

7. The computer system according to claim 6, wherein
the pattern includes a linear or planar pattern.

8. (canceled)

9. The computer system according to claim 6, wherein
the operation further includes
recognizing a texture of a background of the marker apparatus by analysis of the image, and
deciding the pattern according to the texture.

10. The computer system according to claim 9, wherein
the deciding the pattern includes deciding the first pattern in a case in which the texture is sparse and deciding the second pattern in a case in which the texture is dense.

11. The computer system according to claim 6, wherein
the operation further includes
calculating speed of motion that occurs in the image, and
deciding the pattern according to the speed.

12. The computer system according to claim 11, wherein
the first pattern temporally changes,
the second pattern is a pattern that includes temporal change less than the temporal change in the first pattern or does not temporally change, and
the deciding the pattern includes deciding the first pattern in a case in which the speed is low and deciding the second pattern in a case in which the speed is high.

13. The computer system according to claim 6, wherein
the operation further includes detecting a position of the marker apparatus in the image on a basis of an event signal generated by an event-based vision sensor,
the image is acquired by a frame-based vision sensor, and
the pattern includes a pattern that temporally changes at a rate that is an integer multiple of a frame rate of the frame-based vision sensor.

14. (canceled)

15. A method for detecting a position in a real space in an image, the method comprising:
by operation executed by a processor in accordance with a program code stored in a memory,
transmitting a control signal for displaying a pattern that appears as a shape having a size in the image, to a marker apparatus disposed in the real space, wherein
the pattern includes a first pattern including spatial luminance change and a second pattern in which spatial luminance change is less than the spatial luminance change in the first pattern or spatial luminance change does not exist, and
the operation further includes transmitting, to the marker apparatus, a control signal for displaying the first pattern and the second pattern with switching between the first pattern and the second pattern.

16. A program for detecting a position in a real space in an image, the program comprising:
by operation executed by a processor in accordance with the program,
transmitting a control signal for displaying a pattern that appears as a shape having a size in the image, to a marker apparatus disposed in the real space, wherein
the pattern includes a first pattern including spatial luminance change and a second pattern in which spatial luminance change is less than the spatial luminance change in the first pattern or spatial luminance change does not exist, and
the operation further includes transmitting, to the marker apparatus, a control signal for displaying the first pattern and the second pattern with switching between the first pattern and the second pattern.
